(19) United States
(12) Patent Application Publication
(10) Pub. No.: US 2016/0302436 A1
(43) Pub. Date: Oct. 20, 2016

(54) MILK BASED FAT MIXTURE AND A PROCESS FOR PRODUCING IT

(71) Applicant: VALIO OY, Valio (FI)

(72) Inventors: Juha HUUMONEN, Helsinki (FI); Ilona KÖCKRITZ-PERKIÖ, Vantaa (FI)

(21) Appl. No.: 15/101,289

(22) PCT Filed: Dec. 8, 2014
(86) PCT No.: PCT/FI2014/050964

§ 371 Date: Jun. 2, 2016

(30) Foreign Application Priority Data
Dec. 9, 2013 (FI) 20136239

(51) Int. Cl. A23D 7/005; A23C 19/093; A23C 19/076; A23C 9/13

(52) U.S. Cl. CPC A23D 7/0053; A23D 7/0056; A23C 9/1307; A23C 9/1315; A23C 19/093; A23C 19/076

(57) ABSTRACT

The invention relates to a process for the manufacture of a milk based fat mixture, where said process comprises the steps where in the first step milk base selected from mixtures of non-acidified milk base and acidified milk base is mixed with 15-85 wt % of edible plant oil and optionally acidifier, followed by mixing to obtain the fat mixture. The invention also relates to a milk based fat mixture obtainable by said process and to uses of said milk based fat mixture in food products.

### FIELD OF THE INVENTION

The present invention relates to milk based fat mixtures, particularly to emulsions comprising milk derived components and oil, and to a process for producing said milk based fat mixtures. Said milk based fat mixtures are suitable as food products, particularly such as dressings, sauces, toppings, glazings, puddings, gravies, seasoning sauces and the like.

### BACKGROUND OF THE INVENTION

Conventionally, dressings, sauces, toppings, glazings, puddings, gravies and the like contain egg or egg constituents to emulsify the oil or fat contained in said products, and to obtain a stable product. Typically also various additives are included in said products for improving their properties. Egg has excellent functional properties and thus it is widely used particularly in food products where emulsions are required.

For example mayonnaise type products, typically comprising from 60 to 85 wt % of oil, contain egg yolk or whole egg for emulsifying the oil, and for obtaining a stable product having a continuous aqueous phase and a dispersed oil phase.

However, egg also has some disadvantages. It has high cholesterol content. It suffers from microbial complications. Because of this, vulnerable groups of the population are often advised to avoid the consumption of raw egg and products including raw egg. Although the microbial profile can be improved by selective heat treatment, such treatment may adversely affect the functional properties of the egg. The shelf life of functional egg components tends to be short. Moreover, there is a group of people with serious allergic reaction to egg protein. Furthermore, some vegetarians do not wish to consume products that contain egg or egg components.

Several alternative egg extenders, egg replacers and compositions without egg have been proposed in the art. However, in such products, in the form of emulsions, such as mayonnaise, the functional contribution of egg is difficult to replace. When egg yolk is replaced with low molecular weight emulsifiers, such as ethoxylated monoglycerides, diacetyl tartaric acid ester of mono- and diglycerides or hydrolyzed lecithins, oil-in-water emulsion are obtained with low viscosity. Polyoxyethylene-(20)-sorbitan monostearate, at concentrations higher than 1% provides high viscosity emulsions, but the taste is bitter and unacceptable. Viscosity may also be increased with thickening agents, such as gums, polysaccharides and the like, but typically poor texture and/or poor stability is achieved, particularly with high fat emulsions.

High molecular weight emulsifiers have also been proposed as well as acidified protein solutions. In proteins random coiled structures like the ones in casein and skim milk powder precipitate upon direct acidification and thereby proteins lose their emulsifying properties. Proteins with generally compact and inflexible structure, such as whey, soy and pea proteins are mixtures of different types of serum albumins and globulins. They provide in most cases emulsification to yield high viscosity emulsions but said emulsions typically become gelatinized during storage and result in rough texture.

An egg-free mayonnaise-like product is disclosed in EP 0788747 A1, said product comprising from 55 to 85% of fat (plant oil), at least 0.1% of milk proteins selected from skim milk, buttermilk, casein and whey proteins, or of vegetable proteins, where said proteins are denaturated at a degree between 70 and 80%, at least 1% of sugar, 0.5% of salt and 0.1-20% of vinegar. Said product has a pH between 2 and 5. Further, 0.01-2% of low molecular weight emulsifiers selected from monoglycerides, ethoxylated monoglycerides, polyoxyethylene-sorbitans, mono- and diesters of higher fatty acids and glycerin may be used. The denaturation is accomplished by heating the mixture, for example indirectly with steam at 85° C. for 5 minutes, followed by cooling, acidification and homogenizing.

WO 2007/054199 A1 relates to an egg-free mayonnaise-type product having a continuous aqueous phase and a dispersed oil phase. Said product comprises 25-87 wt % of oil and 0.5-15 wt % of a combination of soy protein and whey protein. Said product may also contain an emulsifier, such as lecithin, polyoxyderivative of fatty acid, a thickener, such as gums and starches, and an acid.

There is an evident need for stable emulsions containing significant amounts of fat and proteins derived from milk, said emulsions having pleasant texture and mouth feel, without egg and complicated mixtures of additives, as well as for a process for the manufacture of said emulsions.

### SUMMARY OF THE INVENTION

The present invention relates to a milk based fat mixture comprising proteins, plant oil and water. The milk based fat mixture comprises 0.9-4 wt % of proteins (total amount), 15-85 wt % of edible plant oil, and 20-80 wt % of water. The milk based fat mixture has pH of 3-6.5.

The present invention relates also to a process for the manufacture of a milk based fat mixture, said process comprising the steps where 85-15 wt % of milk base selected from non-acidified milk base and acidified milk base and mixtures thereof, is mixed with 15-85 wt % of edible plant oil followed by mixing to obtain the fat mixture, the percentages being calculated from the total weight of the fat mixture. In the case non-acidified milk base is used, additionally an acidifier is added to the fat mixture to adjust the pH of the fat mixture in the range of 3-6.5. The acidifier may be added with the milk base or with the plant oil, where the acidifier may be mixed with at least portion of the milk base or the plant oil.

According to another embodiment, the present invention relates to food products comprising the milk based fat mixture.

According to another embodiment, the present invention relates to the use of the milk based fat mixture in the manufacture of food products.

Thus an object of the invention is to provide a milk based fat mixture comprising proteins, which milk based fat mixture is egg-free and cholesterol-free, stable and has good organoleptic properties.

Another object of the invention is to provide a process for the manufacture of said milk based fat mixture.

Still another object of the invention is to provide egg-free and cholesterol-free milk based fat mixtures and emulsions, for use as food products or as components in food products.

Characteristic features of the invention are defined in the appended claims.

### DEFINITIONS

The term “egg-free” means here that the product does not contain egg-proteins, material originating from egg yolk, or constituents originating from eggs.

The term “cholesterol-free” means here that the product contains preferably no cholesterol, or at most 0.01 wt % of cholesterol.

The term “butterfat” refers here to all fats originating from milk.

The term “native protein” refers here to non-denatured protein.

The term “casein” refers here to a group of phosphoproteins. Casein is derived from milk. The term “casein” comprises also acid casein, rennet casein, hydrolyzed casein, sodium caseinate, potassium caseinate, magnesium caseinate, calcium caseinate, and combinations thereof.

In an embodiment of the invention, the casein-containing material is microfiltration retentate or ultrafiltration retentate (casein concentrate). In an embodiment the microfiltration retentate is concentrated by ultrafiltration.

In another embodiment, the casein-containing material is milk or quark.

As used herein, the term “milk” means any normal secretion obtained from the mammary glands of mammals, such as cow's, goat's, camel's, horse's or sheep's milk, or any other animal producing milk suitable for nourishment.

The term “whey protein” refers here to proteins present in milk permeate, acid whey, and cheese whey, such as quark and/or cottage cheese whey. Examples of whey proteins are α-lactalbumin and β-lactoglobulin.

The term “milk-permeate” refers here to permeate comprising whey proteins that can be produced from one or more of the fractions obtained by means of membrane techniques. Two or more membrane techniques can be combined including microfiltration, diafiltration, ultrafiltration, nanofiltration and reverse osmosis, in an appropriate manner.

The terms “ideal whey solution”, “ideal whey” and “ideal whey protein solution” are used herein to mean microfiltration (MF) permeate obtained from microfiltration of milk. The term(s) is understood to encompass also a concentrated form of the MF permeate which is obtained as an ultrafiltration retentate from ultrafiltration of the MF permeate. The ideal whey protein solution may contain β-casein in addition to whey proteins. It does not contain fat, other micellar casein monomers or any other by-products from the cheese manufacture. Further, it is free of caseinomacropeptides and thermally formed κ-casein β-lactoglobulin complexes.

Ideal whey solution may be prepared by microfiltration of non-acidified milk base whereby ideal whey solution is obtained as microfiltration permeate (MF-permeate). Microfiltration is typically carried out at a temperature from about 2° C. to about 55° C. Microfiltration may be performed by means of diafiltration to enhance the separation of whey proteins from casein included in milk. The concentration factor in the microfiltration can range from about 1 to about 70. The size of the microfiltration membrane is typically in the range of about 0.05 to about 0.5 μm. The microfiltration permeate may be concentrated by ultrafiltration, whereby the ideal whey protein solution is obtained as an ultrafiltration retentate (UF-retentate). Ultrafiltration is typically performed at about 5° C. to about 55° C. The concentration factor in the ultrafiltration can range from about 10 to about 115.

The protein content of the ideal whey solution can range from about 4% to about 25%. In an embodiment, the protein content of the ideal whey solution is about 5-15%.

### DETAILED DESCRIPTION OF THE INVENTION

The invention is based on the idea of obtaining milk based fat mixtures and particularly emulsions from milk and/or milk derived fractions comprising proteins, and edible plant oils, without additional emulsifiers or thickeners, with a simple and economic process. Milk based fat mixtures and particularly emulsions are obtained, having good stability, pleasant texture, mouth feel and appearance, said milk based fat mixtures being suitable for a wide range of food products and applications. Accordingly milk based fat mixtures and particularly emulsions may be obtained, having a continuous aqueous phase and a dispersed oil phase (oil-in-water).

The process of the invention, for the manufacture of milk based fat mixture, comprises the steps where 85-15 wt % of milk base selected from non-acidified milk base and acidified milk base and mixtures thereof, is mixed with 15-85 wt % of edible plant oil followed by mixing to obtain the fat mixture, the percentages being calculated from the total weight of the fat mixture. In the case non-acidified milk base is used, additionally an acidifier is added to adjust the pH of the fat mixture in the range of 3-6.5 The acidifier may be added with the milk base or with the plant oil, where the acidifier may be mixed with at least portion of the milk base or plant oil.

### Milk Base

The milk base is selected from non-acidified milk bases, acidified milk bases and combinations thereof.

The non-acidified milk base is selected from skim milk, UF-milk (ultra-filtrated milk concentrate), NF-milk (nano-filtrated milk concentrate), casein concentrate, UF-retentate, NF-retentate, ideal whey solution and combinations thereof. Any other milk base raw material may be used, provided it contains approximately same amount of ideal/native whey protein as the above mentioned raw materials (non-acidified milk base materials). Said non-acidified milk base may further comprise whey protein concentrate and/or whey protein isolate for adjusting the whey protein content in the milk base to the desired range.

According to one embodiment the milk base comprises 0-100 wt %, preferably 10-100 wt %, more preferably 20-80 wt % of skim milk.

According to another embodiment the milk base comprises 0-100 wt %, preferably 0-80 wt %, more preferably 10-40 wt % of ideal whey solution.

According to another embodiment the milk base comprises 0-80 wt %, preferably 10-40 wt % of UF-milk. UF-milk typically comprises casein and whey proteins in a ratio from 75:25 to 80:20.

According to another embodiment the milk base comprises 0-100 wt %, preferably 0-80 wt %, more preferably 10-40 wt % of UF-retentate.

According to another embodiment the milk base comprises 0-80 wt %, preferably 10-40 wt % of non-acidified milk selected from ideal whey solution, UF-milk, UF-retentate and combinations thereof.

According to one embodiment the milk base comprises 50-80 wt % of UF-milk and 20-50 wt % of skim milk.

According to another embodiment the milk base consists of an ideal whey solution (MF-permeate).

According to still another embodiment the milk base consists of UF-retentate (micro-filtered milk, permeate that has been Ultra-filtered).

The milk base may optionally be standardized with respect to fat, protein and/or lactose content, and it may be optionally pretreated for microbial removal, using methods known as such, i.e. microfiltration, bactofugation etc.

Suitably the fat (butterfat) content in the milk base is less than 2%, preferably not more than 0.3 wt %.

The milk base may be non-acidified or acidified milk base or a combination thereof. The pH of the acidified milk base is in the range 3-6, preferably 4.2-5.3, more preferably 4.2-5.1.

According to one embodiment the milk base comprises 0-75 wt %, preferably 0-20 wt % and more preferably 0-10 wt % of acidified milk base.

Optionally whey protein concentrate and/or whey protein isolate may be added to the milk base for increasing the whey protein content.

According to one preferable embodiment the whey protein concentrate is a liquid. It is suitably selected from liquid whey protein concentrates (UF retentate or NF-retentate of milk MF-permeate).

The acidified milk base is non-acidified milk base subjected to acidification.

The acidified milk base is suitably selected from quark, yogurt, fresh cheese and combinations thereof.

According to one preferable embodiment the milk base comprises acidified milk base (skim milk fermented with yogurt starter) and non-acidified milk base (skim milk).

The milk base comprises 0.1-10 wt %, preferably 0.3-5 wt %, more preferably 0.5-2 wt % of native, non-denatured whey proteins.

### Manufacture of Milk Base

Non-acidified milk base can be obtained by mixing milk base materials as listed above. In the case only one milk base material is used, it may be used as such or it may be subjected to mixing for providing homogeneous non-acidified milk base.

Acidified milk base may be manufactured with a method where the non-acidified milk base is subjected to heat treatment, followed by acidification where at least one acidifier is added to the heat treated non-acidified milk base, whereby acidified milk base is obtained, such as quark, yogurt, fresh cheese.

In the manufacture of acidified milk base NF-milk and/or UF-milk and/or whey protein concentrate and/or whey protein isolate may be added prior to the heat treatment.

According to one preferable embodiment in the manufacture of acidified milk base 40-60 wt % of casein concentrate and/or 0-20 wt % of UF-milk and 20-60 wt % of skim milk may be added prior to the heat treatment.

In an embodiment the UF-milk comprises 5-15 wt % protein (total). The UF-milk has protein composition similar to milk i.e. it comprises casein and whey proteins in a ratio from 75:25 to 80:20 but less non protein nitrogen.

In an embodiment the whey protein concentrate comprises 5-25 wt % of protein (total). In further embodiment the whey protein concentrate comprises 8-15 wt % of protein (total).

In the manufacture of the acidified milk base the heat treatment is typically carried out at a temperature ranging from about 57 to about 138° C., typically for about 1 s to about 15 min. The heat treatment may comprise one or more heat treatment steps and the heat treatment may also be a combination of different heat treatment techniques. Examples of heat treatment techniques useful in the method are pasteurization, high pasteurization (such as 95° C., 5 min), heating at a temperature lower than the pasteurization temperature for a sufficiently long time, thermization, (such as heating for 2 s to 3 min at approximately 57 to 68° C.), UHT treatment (such as heating at 138° C., 2 to 4 s), ESL treatment (such as heating at 130° C., 1 to 2 s) can be mentioned. The heat treatment can be either direct (vapor to milk, milk to vapor) or indirect (tube heat exchanger, plate heat exchanger, scraped-surface heat exchanger).

According to one embodiment the pasteurization may be carried out at a temperature ranging from about 80 to about 95° C., typically for about 5 s to about 15 min. According to another embodiment the pasteurization may be carried out at a temperature of 84-87° C., typically for about 3 to 7 min.

Optionally cooling is carried out after the heat treatment step. The heat treated milk base may be cooled to a temperature of 27-35° C. Any suitable cooling apparatus may be used, such as heat exchangers etc.

The acidifier is added to the heat treated and optionally cooled milk base. The amount of the acidifier may range between 0.01 and 3%, calculated from the total weight of mixture.

Any acidifier commonly used in the preparation of acidified milk products, particularly in the manufacture of quark, yogurt and fresh cheese can be used in the method. The acidifier is selected from biological acidifiers and chemical acidifiers. Biological acidifiers are typically ferments, starters, DVS starters (direct to vat starter), for instance mesophilic starters (Lactococcus lactis ssp. cremoris, Lactococcus lactis ssp. lactis, Leuconostoc mesenteroides ssp. cremoris and Lactococcus lactis ssp. diacetylactis), or thermophilic starters (Streptococcus thermophiles, Lactobacillus delbrueckii susp. Bulgaricus). Chemical acidifiers are selected from acidogens, organic acids and inorganic acids, such as glucono-delta-lactone, lactic acid, citric acid, hydrochloric acid, oxalic acid, tartaric acid, fumaric acid, succinic acid, malic acid, gluconic acid, adipic acid, and phytic acid, optionally with added calcium salt. Suitably at least one starter is used. In the manufacture of quark the starter is used optionally together with rennet or chymosin. Said rennet or chymosin is suitably added after the pH of the reaction mixture has started to decrease.

If desired a lactose-free or low-lactose product may be produced. Any suitable lactase enzyme may be added simultaneously or subsequently with the acidifier. The amount of the lactase enzyme is typically 0.001-1 wt %.

After the acidifier(s) and optional lactase enzyme is added, acidification, optional lactase treatment and ripening take place whereby acidified milk base is obtained.

The temperature at which acidification, lactase treatment and ripening are carried out can vary within the range of about 20 to about 45° C., depending on the specific acidifier (starter) and enzyme used in the method. In an embodiment, the temperature is 35-45° C. According to another embodiment the temperature is 35-39° C. Typically the ripening is allowed to proceed until the pH is in the range of 4.2-5.2. The ripening time may range from 2 to 25 hours, depending on the acidifier, temperature etc.

Optionally the acidified milk base is subjected to mixing with suitable mixers, such as jet mixers, agitators or the like or using techniques and equipment normally used in the manufacturing of edible milk products. Preferably the acidified milk base is subjected to mixing with an agitator typically used in the field.

Optionally the acidified milk base is cooled to a temperature of 10-20° C.

Optionally the acidified milk base is thermized (heat treated) typically at about 55 to about 68° C. for about 5 to about 20 minutes to enhance the adhesion of the whey proteins to casein. Optionally the thermized acidified milk base is subjected to optional sieving, followed by cooling and optional separation and optional mixing steps.

### Yogurt

Yogurt, suitable for use in the process of the present invention comprises 3-9 wt %, preferably 4-6 wt % of total proteins. Said proteins comprise 70-80 wt %, preferably 75-80 wt % of casein, and 20-30 wt %, preferably 20-25 wt % of whey proteins. Yogurt comprises not more than 2 wt %, preferably not more than 0.3 wt % of butterfat, 0-5 wt %, preferably 1-4.6 wt %, particularly preferably 0.01-4.3 wt % of lactose and it has a pH of 4-5, preferably of 4.2-4.6.

### Quark

Quark, suitable for use in the process of the present invention comprises 8-20 wt %, preferably 10-11 wt % of total proteins. Said proteins comprise 70-100 wt %, preferably 80-100 wt % of casein, and 0-30 wt %, preferably 0-20 wt % of whey proteins. Quark comprises not more than 2 wt %, preferably not more than 0.3 wt % of butterfat, 0-5 wt %, preferably 0.01-4.3 wt % of lactose and it has a pH of 3-6, preferably of 4-5.

Quark (quark mass not subjected to separation or alternatively obtained after separation of whey solution) typically contains totals solids of about 10 to about 28 wt %, preferably about 12-18 wt %.

### Fresh Cheese

Fresh cheese, suitable for use in the process of the present invention comprises 5-20 wt %, preferably 7-10 wt % of total proteins. Said proteins comprise 70-100 wt %, preferably 80-100 wt % of casein, and 0-30 wt %, preferably 10-20 wt % of whey proteins. Fresh cheese comprises not more than 2 wt %, preferably not more than 0.3 wt % of butterfat, 0-5 wt %, preferably 0.01-4.3 wt % of lactose and it has a pH of 4-6, preferably of 4.5-5.5.

### Manufacture of the Fat Mixture

In the process for the manufacture of a fat mixture 85-15 wt % of milk base selected from non-acidified milk bases and acidified milk bases and mixtures thereof, is mixed with 15-85 wt % of edible plant oil followed by mixing to obtain the fat mixture, the percentages being calculated from the total weight of the fat mixture. In the case non-acidified milk base is used, additionally an acidifier is added to adjust the pH of the fat mixture in the range of 4-6.5. The acidifier may be added with the milk base or with the plant oil, where the acidifier may be mixed with at least portion of the milk base or plant oil.

The process may be carried out as a batch process, semi-continuous process or continuous process. According to one embodiment the plant oil (oils) is added as continuous feed in one step or preferably in two or more steps, where each step is followed by vigorous mixing. Preferable said mixing is carried out as high shear mixing. Inline high shear mixers are particularly suitable for producing said fat mixtures on an industrial scale.

The milk base is selected from non-acidified and acidified milk bases and any combinations thereof.

According to a preferable embodiment the non-acidified milk base comprises at least two components selected from skim milk, casein concentrate, UF-retentate and ideal whey solution, and any mixtures thereof, where the amount of skim milk is 0-50 wt %, the amount of casein concentrate is 0-60 wt %, the amount of UF-retentate is 0-60 wt %, and the amount of ideal whey solution is 0-60 wt %.

The casein concentrate refers here to milk MF-retentate obtained from microfiltration of milk. It comprises 5-11 wt % of protein, (typically 8-10 wt % of casein and traces of denatured whey proteins) and it has pH of 6.5-7.0.

The pH of the non-acidified milk base is approximately 6-7.

The pH of the acidified milk base is 4-6, preferably 4.2-5.3, more preferably 4.2-5.1.

The milk base may optionally be mixed, suitably at a temperature below 20° C. using techniques and mixing devices generally used in the field, such as dynamic or static mixers.

The edible plant oil is selected from sunflower oil, rapeseed oil, soy bean oil, cotton seed oil, palm kernel oil, peanut oil, olive oil, maize oil, corn oil, walnut oil, sesame oil, linseed oil, avocado oil, pecan oil, colza oil, almond oil, camelina oil, safflower oil, hempseed oil, pumpkin seed oil and any combinations thereof.

The edible plant oil is mixed with the milk base, to obtain a mixture and the mixture is mixed vigorously in mixing device. Suitable mixing devices are homogenizers, jet mixers, jet mixing turbines, emulsifiers, high shear emulsifiers, power blenders and the like, which are able to provide emulsification and homogenization.

The mixing of the plant oil with the milk base may be carried out at moderate temperatures, suitably at temperatures from 2-30° C., preferably 2-18° C. In a specific embodiment the temperature of the plant oil is 10-23° C.

In the case non-acidified milk base is used an acidifier selected from acetic acid, vinegar acidified milk base, lemon juice, lactic acid, citric acid, hydrochloric acid, oxalic acid, tartaric acid, fumaric acid, succinic acid, malic acid, gluconic acid, adipic acid, phytic acid, glucono delta lactone and another food grade acid, is added with plant oil and mixed. The amount of the acidifier is adjusted to provide a pH of the mixture to 34-6.5, preferably to 4.5-6.5.

A smooth homogeneous emulsion (fat mixture) is obtained.

Optional additives may be added to the obtained mixture, followed by mixing, or alternatively during the mixing of the plant oil with the milk base. Said additives may be selected from salt, sweeteners (such as sugar, corn syrup, maltodextrins, dextrose, saccharine, acesulfame, sucralose, stevia alcaloids, aspartame, sugar alcohols, etc.), acetic acid, vinegar, aromas, spices, flavors (such as vanilla, hazelnut, Irish crème, mocha, almond, liqueurs, chocolate, berry, fruit etc.), seasonings, cocoa, mustard, coloring agents, tomato, sweet pepper, vitamins, antioxidants (such as ethoxyquin, vitamin E, BHA, BHT, TBHQ, ascorbyl palmitate), preservatives (such as sorbates, benzoates etc.) and the like.

### Milk Based Fat Mixture

The milk based fat mixture is an egg-free and cholesterol-free, protein containing emulsion product derived from milk and comprising preferably little or no butter fat. Said mixture is typically an emulsion having a continuous aqueous phase and a dispersed oil phase.

The milk based fat mixture comprises 0.2-10 wt % of proteins (total amount), 15-85 wt % of edible plant oil, and 20-80 wt % of water. The milk based fat mixture has pH of 3-6.5, preferably 4.5-6.5.

The fat mixture comprises 0.2-10 wt %, preferably 0.3-5 wt and particularly preferably 0.5-3 wt % of proteins (total).

Suitably at least 50 wt % of said proteins (total) comprise casein, preferably 70-96 wt %, preferably 75-96 wt % of said proteins comprise casein.

Suitably 0.5-30 wt %, preferably 0.6-28 wt %, particularly preferably 1.4-5 wt % of said proteins (total) comprise whey proteins comprising native and denaturated whey proteins.

Suitably 0.5-20 wt % of said proteins (total) comprises native whey proteins. This corresponds to 0.1-3 wt % of native whey proteins in the fat mixture.

Suitably 0.6-3 wt % of said proteins comprises native whey proteins.

Suitably native whey proteins comprise β-lactoglobulin and α-lactalbumin. Said proteins may comprise additionally denatured whey proteins.

In one preferably embodiment the proteins comprise 0.6-3 wt % of native whey proteins.

In another embodiment of the invention, the proteins comprise 75-85 wt % of casein and 15-25 wt % of whey proteins.

The fat mixture comprises 15-85 wt %, preferably 50-71 wt % of edible plant oil.

The fat mixture comprises 20-80wt %, preferably 20-50 wt % of water.

The fat mixture comprises 0-2 wt %, preferably not more than 0.3 wt % of butterfat.

The fat mixture comprises 0-5 wt %, preferably 0.001-4.3 wt % of lactose.

The pH of the fat mixture (product) is 3-6.5, preferably 4.5-6.5.

The fat mixture or emulsion may also comprise one or more additives. Said additives may be selected from salt, sweeteners (such as sugar, corn syrup, maltodextrins, dextrose, saccharine, acesulfame, sucralose, stevia alcaloids, aspartame, sugar alcohols, etc.), acetic acid, vinegar, aromas, spices, flavors (such as vanilla, hazelnut, irish crème, mocha, almond, liqueurs, chocolate, berry, fruit etc.), seasonings, cocoa, mustard, coloring agents, tomato, sweet pepper, vitamins, antioxidants (such as ethoxyquin, vitamin E, BHA, BHT, TBHQ, ascorbyl palmitate), preservatives (such as sorbates, benzoates etc.) and the like.

No additional emulsifiers or thickening agent are needed in the product.

The product has very pleasant texture, structure, nice gloss, mouth feel and appearance, and good stability. The natural color of the fat mixture is white. However the color may differ from white depending on the color of the oil used. No membrane (skin or peel) is formed on the fat mixture or emulsion when spread.

Said fat mixture is suitable for a wide range of food products and applications. Examples of applications are use as mayonnaise and in food products containing mayonnaise, as well as sauces, seasoning sauces, dressings, gravies, topping, glazings, puddings, etc.

The following examples are illustrative of embodiments of the present invention, as described above, and they are not meant to limit the invention in any way.

### EXAMPLES

### Example 1

### Manufacture of Milk Base

### Example 1.1

Skim milk 40 wt % and UF-milk (ultra-filtrated milk concentrate) 60 wt % were mixed. The mixture was then pasteurized at 85° C. for 3-4 minutes. The mixture was cooled to 30° C. and 0.1 wt % of starter culture (YO MIX) was added. The blend was mixed for 10 minutes and fermented at 35-45° C. for about 5.5-6 hours or until pH was about 4.9. The obtained acidified milk base (yogurt-like product) was mixed and cooled to a temperature of 13° C.

### Example 1.2

2400 g casein concentrate (9% protein) and 600 g skim milk was mixed. The mixture was pasteurized at 85° C. for 5 minutes and then cooled to 42° C. 1.5 g of starter (YO MIX) was added to the blend and incubated/fermented until pH 4.9 was attained. Finally the obtained acidified milk base was cooled to about 13° C.

### Example 1.3

1800 g casein concentrate (9% protein), 600 g UF-milk (ultra-filtrated milk concentrate) and 600 g skim milk was mixed. The mixture was pasteurized at 85° C. for 5 minutes and then cooled to 42° C. 1.5 g of starter (YO MIX) was added to the blend and fermented until pH 4.9-5 was attained.

### Example 1.4

75 g of quark (comprising 0.3 wt % fat, 11 wt % protein and 3 wt % lactose) was mixed with 925 g of pasteurized skim milk to obtain milk base (blend). The milk base had pH of 6.3.

### Example 1.5

100 g of quark (acidified milk base) was mixed with 900 g of pasteurized skim milk (non-acidified milk base) to obtain milk base blend.

### Example 1.6

500 g of unseasoned plain yogurt was mixed with 500 g of skim milk to obtain milk base mixture/blend. Unseasoned plain yogurt contained 4.5 wt % proteins, less than 1% of lactose and less than 0.4 wt % of fat.

### Example 2

### Manufacture of Fat Mixture

### Example 2.1

The milk base obtained in example 1.4 (1000 g) was mixed with 2500 g of rapeseed oil and homogenized with a blender to obtain a smooth white mayonnaise type emulsion. The pH of the obtained fat mixture was about 6.3, it contained 71 wt % of plant oil (fat), about 26 wt % of water, about 0.01 wt % lactose and 1.1 wt % of protein of which about 80-85 wt % casein and 15-20 wt % whey protein. The milk fat content was <0.1 wt %.

### Example 2.2

The milk base blend obtained in example 1.5 (1000 g) was mixed with 2500 g rapeseed oil and the mixture was mixed with blender. The resulting fat mixture was thick, white emulsion with a pleasant smooth mouth feel and extrudable/formable/shapeable structure. The pH of the fat mixture was 6.2, it contained 71 wt % of plant oil, about 25 wt % of water and about 1.2 wt % proteins of which about 80-85% casein and 15-20 wt % of whey protein. The milk fat content was <0.1 wt %.

### Example 2.3

150 g of plain yogurt and 850 g of skim milk were mixed and 2500 g of rapeseed oil was added and the obtained mixture was mixed with blender to obtain a smooth white mayonnaise type emulsion with a pleasant mild taste. The pH of the mixture was 6 and the amount of oil 71 wt %. Fat mixture comprised 1 wt % protein of which about 80 wt % casein and 20 wt % whey protein, 0.01 wt % lactose, about 26 wt % water. The milk fat content was <0.04 wt %.

### Example 2.4

The milk base mixture obtained in example 1.6 (1000 g) was mixed with 2500 g rapeseed oil and the mixture was mixed with a blender. The resulting fat mixture was very thick, white emulsion with an extrudable/formable/shapeable structure. The pH of the fat mixture was 5, it contained 71 wt % of plant oil, about 26 wt % of water and about 1.2 wt % protein. The milk fat content was <0.06 wt %.

### Example 2.5

30 g of quark (11 wt % protein, 0.3 wt % fat and 3 wt % lactose) and 970 g of skim milk were mixed with 2500 g sunflower oil and the mixture was mixed with blender. The resulting fat mixture was mayonnaise type white emulsion. The fat mixture comprised 71 wt % of plant oil, about 26 wt % water and about 1 wt % protein. The milk fat content was <0.03 wt %.

### Example 2.6

33 g of quark (11 wt % protein, 0.3 wt % fat and 3 wt % lactose) and 67 g of skim milk were mixed with 150 g rapeseed oil and the mixture was mixed with blender. The resulting fat mixture was a thick white emulsion suitable for use as a mayonnaise. The fat mixture comprised 60 wt % of plant oil, about 36 wt % of water and about 2.3 wt % of protein. The milk fat content was <0.07 wt %.

### Example 2.7

43 g of quark (11 wt % protein, 0.3 wt % fat and 3 wt % lactose) and 57 g of skim milk was mixed with 100 g rapeseed oil and the mixture was mixed with blender. The resulting fat mixture comprised 50 wt % of plant oil, about 44 wt % of water and about 3.3 wt % of protein. The fat mixture was a smooth, sauce type white emulsion. The milk fat content was <0.1 wt %.

The present invention has been described herein with reference to specific embodiments. It is, however clear to those skilled in the art that the process(es) may be varied within the bounds of the claims.

1. A process for the manufacture of a fat mixture, characterized in that said process comprises the steps where 85-15 wt % of milk base selected from mixtures of non-acidified milk base and acidified milk base, is mixed with 15-85 wt % of edible plant oil followed by mixing to obtain the fat mixture, the percentages being calculated from the total weight of the fat mixture.

2. The process according to claim 1, characterized in that the non-acidified milk base is selected from skim milk, UF-milk, NF-milk, casein concentrate, UF-retentate, NF-retentate, ideal whey solution and combinations thereof.

3. The process according to claim 1, characterized in that the milk base comprises 0-100 wt %, preferably 10-100 wt % of skim milk.

4. The process according to claim 1, characterized in that the milk base comprises 0-75 wt %, preferably 0-20 wt % of acidified milk base.

5. The process according to claim 1, characterized in that the acidified milk base is selected from quark, yogurt, fresh cheese and combinations thereof.

6. The process according to claim 1, characterized in that an acidifier is added to adjust the pH of the fat mixture in the range of 3-6.5.

7. The process according to claim 6, characterized in that the acidifier is added to the milk base or to the plant oil.

8. The process according to claim 6, characterized in that the acidifier is selected from acetic acid, vinegar, acidified milk base, glucono delta lactone, lemon juice, lactic acid, citric acid, hydrochloric acid, oxalic acid, tartaric acid, fumaric acid, succinic acid, malic acid, gluconic acid, adipic acid and phytic acid and any combinations thereof.

9. The process according to claim 1, characterized in that the plant oil is selected from sunflower oil, rapeseed oil, soy bean oil, cotton seed oil, palm kernel oil, peanut oil, olive oil, maize oil, corn oil, walnut oil, sesame oil, linseed oil, avocado oil, pecan oil, colza oil, almond oil, camelina oil, safflower oil, hempseed oil, pumpkin seed oil and any combinations thereof.

10. The process according to claim 1, characterized in that the mixing is carried out with a homogenizer, jet mixer, jet mixing turbine, emulsifier, high shear emulsifier or power blender.

11. The process according to claim 1, characterized in that the mixing is carried out at the temperatures of 2-30° C.

12. The process according to claim 1, characterized in that one or more additives selected from salt, sweeteners, acetic acid, vinegar, aromas, spices, flavors, seasonings, cocoa, mustard, coloring agents, tomato, sweet pepper, vitamins, antioxidants, preservatives are added to the fat mixture.

13. A milk based fat mixture, characterized in that said milk based fat mixture comprises 15-85 wt % of at least one edible plant oil, 20-80 wt % of water, 0.2-10 wt % of proteins, and at least 50 wt % of said proteins comprise casein and 0.5-20 wt % of said proteins comprise native whey proteins and the milk based fat mixture has pH of 3-6.5.

14. The milk based fat mixture according to claim 13, characterized in that the milk based fat mixture comprises 0-2 wt % of butterfat.

15. The milk based fat mixture according to claim 13, wherein the milk based fat mixture comprises one or more additives selected from salt, sweeteners, acetic acid, vinegar, aromas, spices, flavors, seasonings, cocoa, mustard, coloring agents, tomato, sweet pepper, vitamins, antioxidants, preservatives.

16. The milk based fat mixture according to claim 13, characterized in that 0.6-3 wt % of the proteins comprise native whey proteins.

17. The milk based fat mixture according to claim 13, characterized in that the plant oil is selected from sunflower oil, rapeseed oil, soy bean oil, cotton seed oil, palm kernel oil, peanut oil, olive oil, maize oil, corn oil, walnut oil, sesame oil, linseed oil, avocado oil, pecan oil, colza oil, almond oil, camelina oil, safflower oil, hempseed oil, pumpkin seed oil and any combinations thereof.

18. The milk based fat mixture according to claim 13, characterized in that the milk based fat mixture comprises 0-5 wt % of lactose.

19. The milk based fat mixture according to claim 13, characterized in that 70-96 wt % of the proteins comprise casein.

20. A food product comprising the milk based fat mixture according to claim 13.

21. Use of the milk based fat mixture according to claim 13 in the manufacture of food products.
